(19) United States
(12) Patent Application Publication
(10) Pub. No.: US 2010/0208850 A1
(43) Pub. Date: Aug. 19, 2010

(54) SYNCHRONIZING INITIALIZATION DATA TO TIME BURSTS IN A MOBILE COMMUNICATIONS SYSTEM

(75) Inventors: David Brian Anderson, Florence, NJ (US); David Anthony Campana, Princeton, NJ (US); Avinash Sridhar, Plainsboro, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing, Princeton, NJ (US)

(21) Appl. No.: 12/734,063

(22) PCT Filed: Oct. 28, 2008
(86) PCT No.: PCT/US08/12219

§ 371 Date: Apr. 8, 2010

Related U.S. Application Data
(60) Provisional application No. 61/001,484, filed on Oct. 31, 2007.

(51) Int. Cl. H04L 27/00

(52) U.S. Cl. 375/340; 375/295

(57) ABSTRACT

An apparatus encodes a signal for providing an MPEG-2 encoded signal having associated initialization data such as I-frames; and transmits the signal, wherein the transmitted signal occurs in bursts for conveying the MPEG-2 encoded signal, wherein each burst has a duration and occurs in a time slicing cycle, each time slicing cycle comprising at least the burst duration and an off-time, and wherein at least one I-frame is conveyed in a burst and repeated in every following burst until a new I-frame is received for transmission.

### CROSS-REFERENCE TO RELATED APPLICATIONS

This application claims the benefit of U.S. Provisional Application No. 61/001,484, filed Oct. 31, 2007.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

Today, mobile devices are everywhere—from MP3 players to personal digital assistants to cellular telephones to mobile televisions (TVs). Unfortunately, a mobile device typically has limitations on computational resources and/or power. In this regard, an Internet Protocol (IP) Datacast over Digital Video Broadcasting—Handheld (DVB-H) system is an end-to-end broadcast system for delivery of any type of file and service using IP-based mechanisms that is optimized for such devices. For example, see ETSI EN 302 304 V1.1.1 (2004-11) “Digital Video Broadcasting (DVB); Transmission System for Handheld Terminals (DVB-H)”; ETSI EN 300 468 V1.7.1 (2006-05) “Digital Video Broadcasting (DVB); Specification for Service Information (SI) in DVB systems”; ETSI TS 102 472 V1.1.1 (2006-06) “Digital Video Broadcasting (DVB); IP Datacast over DVB-H: Content Delivery Protocols”; ETSI EN 301 1924 V1.4.1 (2004-06), “Digital Video Broadcasting (DVB); DVB specification for data broadcasting” and ETSI TS 102 471 V1.1.1 (2006-04) “Digital Video Broadcasting (DVB); IP Datacast over DVB-H: Electronic Service Guide (ESG)”. An example of an IP Datacast over DVB-H system as known in the art is shown in FIG. 1. In FIG. 1, a head-end 10 (also referred to herein as a “sender”) broadcasts, via antenna 35, a DVB-H signal 36 to one, or more, receiving devices (also referred to herein as “clients” or “receivers”) as represented by receiver 90. The DVB-H signal 36 conveys the IP Datacasts to the clients. Receiver 90 receives DVB-H signal 36, via an antenna (not shown), for recovery therefrom of the IP Datacasts. The system of FIG. 1 is representative of a unidirectional network.

In particular, in a DVB-H system data is transmitted in bursts as a series of discrete packets. These time slices of data can be used to separate different services offered on a physical broadcast channel. This allows a battery powered receiver to conserve power by only turning its radio on for those time intervals when relevant data is available. This is illustrated in FIG. 2. A broadcaster broadcasts a signal (e.g., DVB-H signal 36 of FIG. 1) conveying a transport stream for a service in a time slicing fashion as illustrated by time slicing cycle 40. The latter comprises a burst of data, or data burst 45, following by a period of silence during which the broadcaster ceases transmission for that service. Data burst 45 lasts for a burst duration interval 41 (or on-time) and the period of silence lasts for an off-time 42. During the off-time interval 42, at least a portion of the receiver can power-down, thus saving power. The receiver then powers-up when it is time to receive the next burst 55 for that service.

The amount of time, or length, of a time slicing cycle for a given service is a function of system design and can vary. This interval dictates the average time needed for a receiver to begin receiving data for a service. According to the DVB-H Project Office, present technology allows for an interval of two to four seconds between bursts resulting in an average service acquisition time of one to two seconds.

However, depending on the specific data offered by a service, further complications may exist that can add to the time required for the service to be fully available at the receiver for a user. In particular, the receiver may have to receive initialization data before the receiver can process the received data stream. For example, video coding schemes that require an initial Intra-frame (I-frame) be received and decoded by the receiver before subsequent predicted frames (P-frames) can be decoded can add delay. As such, when the receiver initially turns on, or even during a channel change, the receiver may have to wait for the data burst that conveys that first I-frame—thus, making the user wait for the service. Another example is the video standard H.264 (ITU-T Recommendation H.264 and ISO/IEC 14496-10 (MPEG-4 part 10) Advanced Video Coding, October 2004), which requires parameter sets be first received and passed to the decoder before any video frames can be decoded. Again, when the receiver initially turns on, or switches to a new channel, the receiver will have to wait for the particular data burst conveying the parameter sets. And, as a final example, synchronization data may be required in order to synchronize multiple streams of data. For example, a service may consist of an audio stream and a video stream, both transmitted as separate RTP (Real-Time Protocol) streams (e.g., see H. Schulzrinne, S. Casner, R. Frederick, V. Jacobson, “RFC 1889—RTP: A Transport Protocol for Real-Time Applications,” IETF, January 1996). Synchronization of these streams requires that the receiver receive RTCP (Real-Time Control Protocol) sender reports in order to determine a common reference clock for the separate RTP streams. Without these RTCP sender reports, the receiver will be unable to properly synchronize the video and the audio together—thus, again adding delay while the receiver waits for the RTCP sender reports.

### SUMMARY OF THE INVENTION

As described above, a receiver may have to wait for initialization data before being able to fully present a service—thus increasing service acquisition time. In fact, a receiver may have to wait for multiple data bursts before finally receiving a data burst conveying the required initialization data. Therefore, and in accordance with the principles of the invention, an apparatus encodes a signal for providing an encoded signal having associated initialization data; and transmits the encoded signal, wherein the transmitted signal occurs in bursts for conveying the encoded signal, wherein each burst has a duration and occurs in a time slicing cycle, each time slicing cycle comprising at least the burst duration and an off-time, and wherein the initialization data is sent in a burst and repeated in every following burst until new initialization data is received for transmission.

In an illustrative embodiment of the invention, an apparatus provides a service that includes video. In particular, the apparatus encodes a signal for providing an MPEG-2 encoded signal having associated initialization data such as I-frames; and transmits the signal, wherein the transmitted signal occurs in bursts for conveying the MPEG-2 encoded signal, wherein each burst has a duration and occurs in a time slicing cycle, each time slicing cycle comprising at least the burst duration and an off-time, and wherein at least one I-frame is conveyed in a burst and repeated in every following burst until a new I-frame is received for transmission.

In another illustrative embodiment of the invention, an apparatus receives a signal, wherein the signal occurs in bursts and conveys an MPEG-2 encoded signal, wherein each burst has a duration and occurs in a time slicing cycle, each time slicing cycle comprising at least the burst duration and an off-time; recovers initialization data, e.g., at least one I-frame, from every received burst, and discards a recovered I-frame that has been repeated from a previously received burst. As a result, the apparatus can fully utilize the MPEG-2 encoded video within each burst thus facilitating faster channel acquisition and recovery from errors.

In another illustrative embodiment of the invention, an apparatus provides a service that includes video. In particular, the apparatus encodes a signal for providing an H.264 encoded signal having associated initialization data such as parameter sets; and transmits the signal, wherein the transmitted signal occurs in bursts for conveying the H.264 encoded signal, wherein each burst has a duration and occurs in a time slicing cycle, each time slicing cycle comprising at least the burst duration and an off-time, and wherein at least one parameter set is conveyed in a burst and repeated in every following burst until a new parameter set is received for transmission.

In another illustrative embodiment of the invention, an apparatus receives a signal, wherein the signal occurs in bursts and conveys an H.264 encoded signal, wherein each burst has a duration and occurs in a time slicing cycle, each time slicing cycle comprising at least the burst duration and an off-time; recovers initialization data, e.g., at least one parameter set, from every received burst, and discards a recovered parameter set that has been repeated from a previously received burst. As a result, the apparatus can fully utilize the H.264 encoded video within each burst thus facilitating faster channel acquisition and recovery from errors.

In another illustrative embodiment of the invention, an apparatus provides a service that includes video and audio, which are transmitted as separate RTP streams. In particular, the apparatus encodes a signal for providing separate RTP streams for video and audio, the video and audio streams having associated initialization data such as RTCP sender reports; and transmits the signal, wherein the transmitted signal occurs in bursts for conveying the video and audio streams, wherein each burst has a duration and occurs in a time slicing cycle, each time slicing cycle comprising at least the burst duration and an off-time, and wherein at least one RTCP sender report is conveyed in a burst and repeated in every following burst until a new RTCP sender report is received for transmission.

In another illustrative embodiment of the invention, an apparatus receives a signal, wherein the signal occurs in bursts and conveys separate video and audio RTP streams, wherein each burst has a duration and occurs in a time slicing cycle, each time slicing cycle comprising at least the burst duration and an off-time; recovers initialization data, e.g., at least one RTCP sender report, from every received burst, and discards a recovered RTCP sender report that has been repeated from a previously received burst. As a result, the apparatus can fully utilize the separate RTP streams within each burst thus facilitating faster channel acquisition and recovery from errors.

In another illustrative embodiment of the invention, an apparatus provides a service that includes video. In particular, the apparatus encodes a signal in accordance with RObust Header Compression (ROHC) (RFC 3095) for providing an ROHC encoded signal having associated initialization data such as periodic initialization and refresh (IR) packets; and transmits the signal, wherein the transmitted signal occurs in bursts for conveying the ROHC encoded signal, wherein each burst has a duration and occurs in a time slicing cycle, each time slicing cycle comprising at least the burst duration and an off-time, and wherein at least one IR packet is conveyed in a burst and repeated in every following burst until a new IR packet is received for transmission.

In another illustrative embodiment of the invention, an apparatus receives a signal, wherein the signal occurs in bursts and conveys an ROHC encoded signal, wherein each burst has a duration and occurs in a time slicing cycle, each time slicing cycle comprising at least the burst duration and an off-time; recovers initialization data, e.g., at least one IR packet, from every received burst, and discards a recovered IR packet that has been repeated from a previously received burst. As a result, the apparatus can fully utilize the ROHC encoded video within each burst thus facilitating faster channel acquisition and recovery from errors.

In view of the above, and as will be apparent from reading the detailed description, other embodiments and features are also possible and fall within the principles of the invention.

### BRIEF DESCRIPTION OF THE DRAWINGS

FIGS. 1-2 shows a prior art Internet Protocol (IP) Datacast over Digital Video Broadcasting—Handheld (DVB-H) system;

FIG. 3 further illustrates a prior art time-slicing transmission;

FIG. 4 shows an illustrative embodiment in accordance with the principles of the invention;

FIGS. 5 and 6 show illustrative flow charts for use in a transmitter in accordance with the principles of the invention;

FIG. 7 shows an illustrative flow chart for use in a receiver in accordance with the principles of the invention;

FIG. 8 shows an illustrative embodiment of a transmitter in accordance with the principles of the invention; and

FIG. 9 shows an illustrative embodiment of a receiver in accordance with the principles of the invention.

### DETAILED DESCRIPTION

Other than the inventive concept, the elements shown in the figures are well known and will not be described in detail. For example, other than the inventive concept, familiarity with Discrete Multitone (DMT) transmission (also referred to as Orthogonal Frequency Division Multiplexing (OFDM) or Coded Orthogonal Frequency Division Multiplexing (COFDM)) is assumed and not described herein. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC), Chinese Digital Television System (GB) 20600-2006 and DVB-H is assumed. Likewise, other than the inventive concept, other transmission concepts such as eight-level vestigial sideband (8-VSB), Quadrature Amplitude Modulation (QAM), and receiver components such as a radio-frequency (RF) front-end (such as a low noise block, tuners, down converters, etc.), demodulators, correlators, leak integrators and squarers is assumed. Further, other than the inventive concept, familiarity with protocols such as the File Delivery over Unidirectional Transport (FLUTE) protocol, Asynchronous Layered Coding (ALC) protocol, Internet protocol (IP) and Internet Protocol Encapsulator (IPE), is assumed and not described herein. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

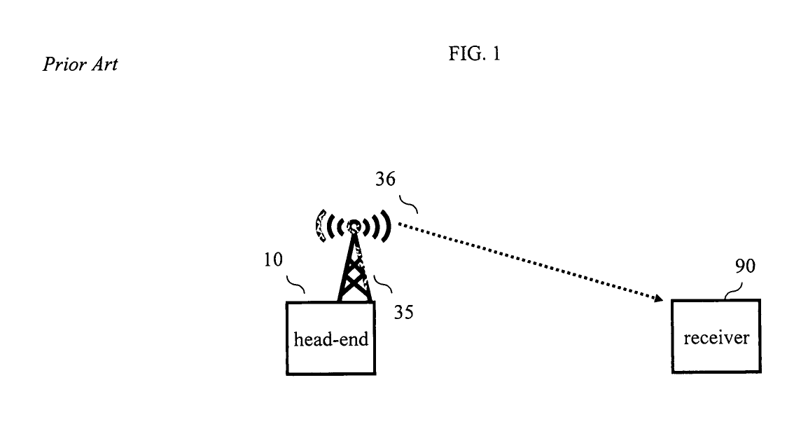

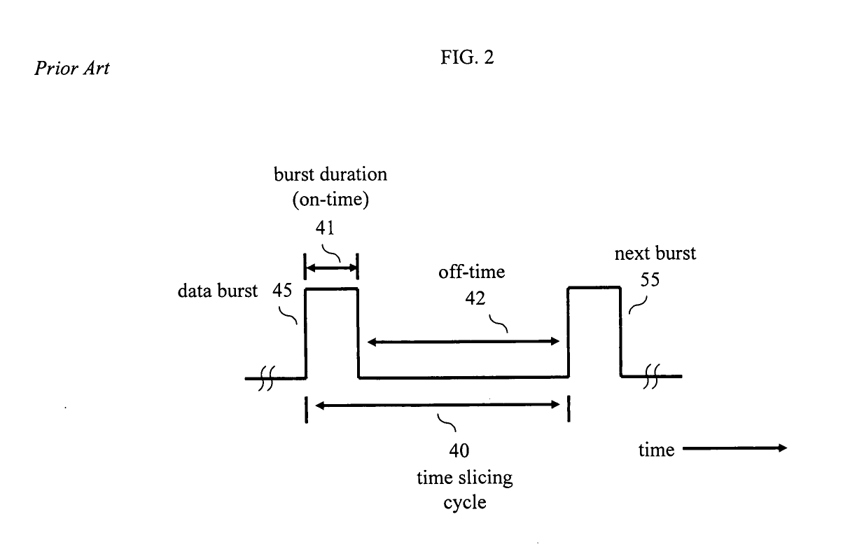

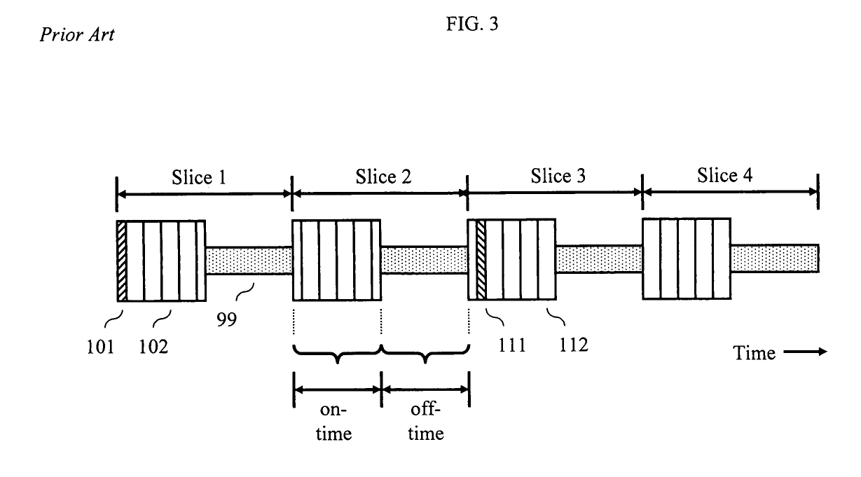

As noted earlier, when a receiver initially turns on, or even during a channel change or even if just changing services within the same channel, the receiver may have to additionally wait for that data burst that conveys the required initialization data before being able to process any received data. As a result, the user has to wait an additional amount of time before being able to access a service or program. This is further illustrated in FIG. 3, which shows an example of a stream of data being split into time-slice bursts without regard to the content of the data for a particular service, e.g., a “service A” being transmitted on a particular broadcast channel. In particular, a transmitter, e.g., head-end 10 of FIG. 1, broadcasts a signal on a channel conveying a transport stream for “service A” in a time slicing fashion as illustrated by the sequence of slices, i.e., slice 1, slice 2, slice 3 and slice 4 of FIG. 3. In each time slicing cycle there is an on-time and an off-time for that particular service. It should be noted that during the off-time for “service A”, other data may be transmitted on the same channel, i.e., in another time slice, for a different service, e.g., a “service B”. This is illustrated by stippled block 99 in FIG. 3. With regard to “service A”, the cross-hatched blocks represent initialization data and the white blocks represent distinct units of content data. For example, in the context of MPEG2 encoding, initialization data 101 represents an I-frame, while content data 102 represents a P-frame. As can be observed from FIG. 3, slice 2 does not contain initialization data. In order for a receiver to process the content data in slice 2, the receiver must have received the initialization data 101 from slice 1. As such, if a receiver tunes in to receive “service A” and initially receives slice 2, the receiver cannot process any of the data since the receiver missed receiving initialization data 101. As such the receiver must wait till slice 3, when a new I-frame, represented by initialization data 111 can be received. Upon receiving initialization data 111 in slice 3, the receiver is now able to process any subsequent content data as represented by content data 112.

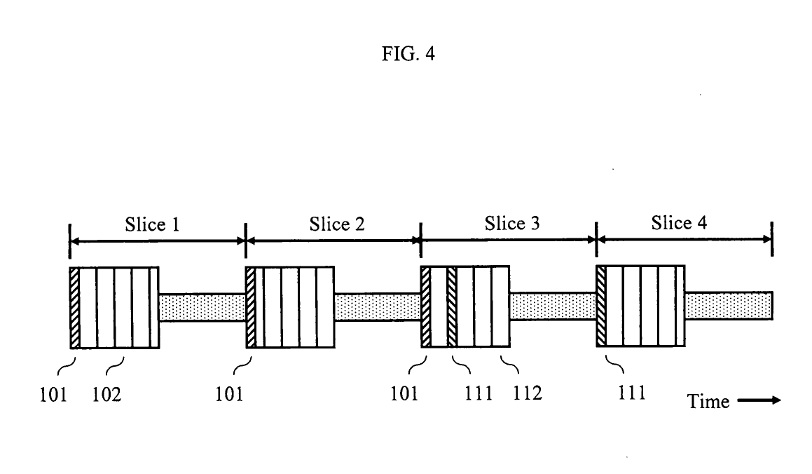

Turning now to FIG. 4, an illustrative embodiment in accordance with the principles of the invention is shown. In particular, and in accordance with the principles of the invention, an apparatus encodes a signal for providing an encoded signal having associated initialization data; and transmits the encoded signal, wherein the transmitted signal occurs in bursts for conveying the encoded signal, wherein each burst has a duration and occurs in a time slicing cycle, each time slicing cycle comprising at least the burst duration and an off-time, and wherein the initialization data is sent in a burst and repeated in every following burst until new initialization data is received for transmission. As can be observed from FIG. 4, initialization data is present in every burst. Thus, even if a receiver first tunes into receive “service A” during slice 2, the receiver is still able to process the content data in slice 2 since slice 2 also repeats the initialization data 101 first transmitted in slice 1. Initialization data 101 is repeated until a new I-frame occurs. This is illustrated in slices 3 and 4. In slice 3, initialization data 101 is again repeated and, in addition, a new I-frame, represented by initialization data 111 is also transmitted in slice 3. As such, in the next slice 4, initialization data 111 is now repeated. Thus, this invention synchronizes initialization parameters to these bursts so that the data within each burst can be fully utilized by the receiver, facilitating faster channel or service acquisition and recovery from errors. As can be observed from FIG. 4, the added initialization data takes up transmission bandwidth that was previously used by content data—thus there is some tradeoff of bandwidth for quicker acquisition time.

With regards to the need of additional bandwidth for repeating initialization data in every burst this may be addressed in a number of ways. First, data sources such as video and audio encoders may support the ability to control the output bitrate of the encoder. Thus, the bandwidth of the content data may be reduced, e.g., by reducing the bitrate of the encoded video, in order to accommodate the bandwidth required for repeating the initialization data. Alternatively, the “on-time” for a burst may be increased to provide the required bandwidth, thus slightly increasing the duration of a time slicing cycle. Finally, it should also be noted that initialization data tends to be very small and may fit within the portion of a time slice typically used for padding in existing systems. In fact, a feedback mechanism can be used between a time slicing unit and an encoder so that the time slicing unit may report to the encoder the amount of remaining space in the time slice available after the initialization data so that the encoding bitrate may be adjusted to compensate for the presence of the initialization data.

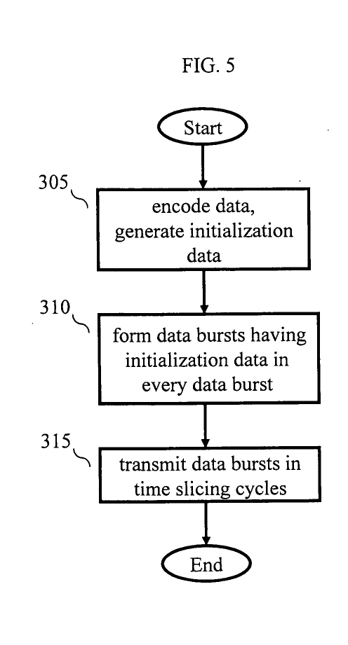

An illustrative flow chart in accordance with the principles of the invention for use in a transmitter is shown in FIG. 5. In step 305, the transmitter encodes data, e.g., in accordance with MPEG-2, and generates encoded data, a portion of which represents initialization data such as an I-frame. In step 310, the transmitter forms data bursts for conveying the encoded signal, wherein each burst has a duration and occurs in a time slicing cycle, each time slicing cycle comprising at least the burst duration and an off-time, and wherein the initialization data is sent in a burst and repeated in every following burst until new initialization data is received for transmission. Finally, in step 315, the transmitter transmits the data bursts in time slicing cycles.

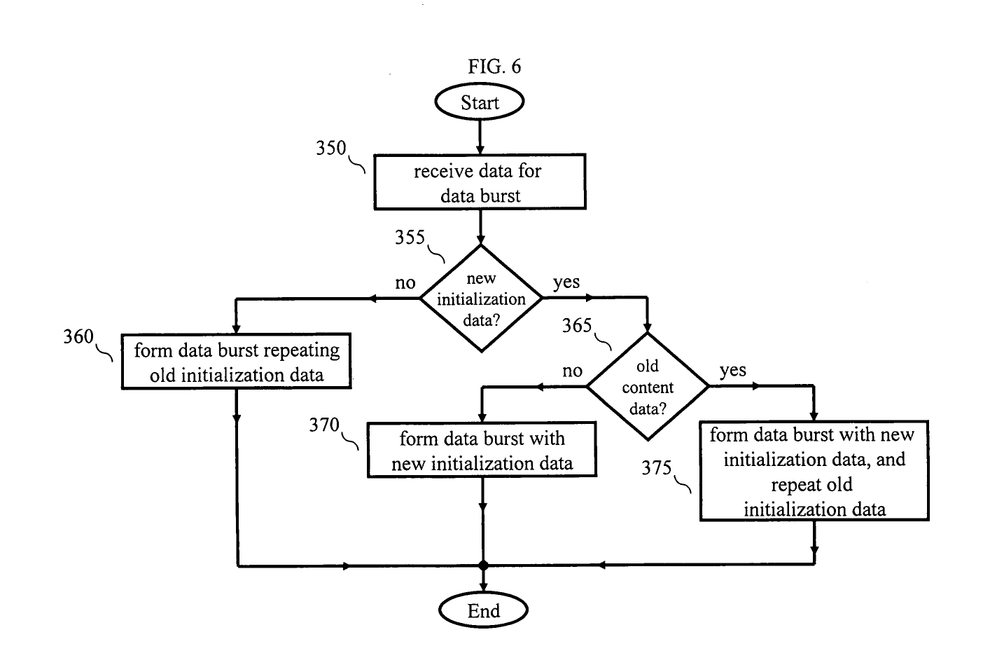

Turning now to FIG. 6, an illustrative flow chart in accordance with the principles of the invention for use in forming a data burst in step 310 of FIG. 5 is shown. In step 350, the transmitter receives the encoded data for a particular data burst. In step 355, the transmitter checks if “new” initialization data is included in the received data. If there is no “new” initialization data, i.e., the received data just comprises content data (e.g., a P-frame in MPEG-2) that requires previously determined or “old” initialization data, e.g., an I-frame in MPEG-2, then the transmitter repeats the “old” initialization data in this data burst. On the other hand, if there is “new” initialization data, e.g., a new I-frame in MPEG-2, then the transmitter checks if there is “old” content data in the received data for this data burst in step 365. In this context, “old” content data requires the “old” initialization data. If there is no “old” content data, then the transmitter forms the data burst with the “new” initialization data. However, if there is “old” content data in the received data, then the transmitter forms the data burst repeating the “old” initialization data along with the “new” initialization data. In any event, it should be noted that on the immediately following data burst, the “new” initialization data is now treated as “old” initialization data for forming the next data burst.

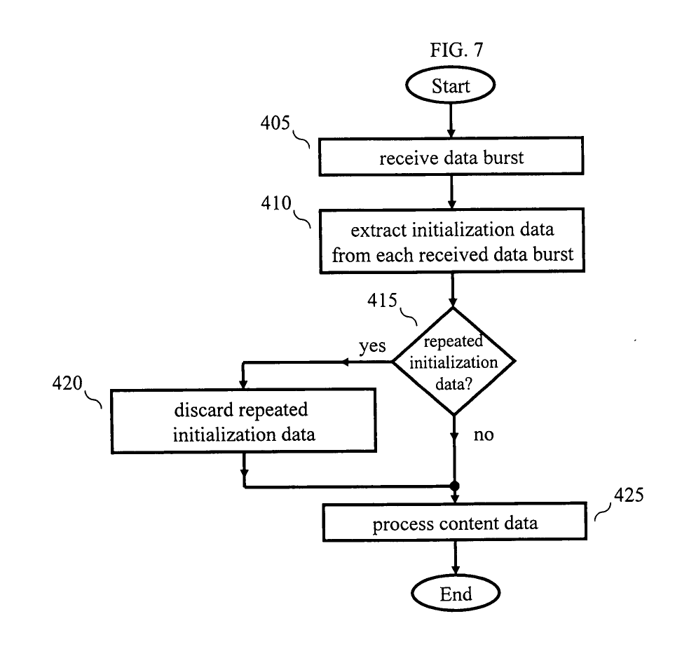

Referring now to FIG. 7, an illustrative flow chart in accordance with the principles of the invention for use in a receiver is shown. In step 405, a receiver receives a data burst. In step 410, the receiver extracts initialization data from each received data burst. For example, in the context of MPEG-2, each received data burst comprises at least one I-frame. In step 415, the receiver checks if the extracted initialization data is repeated initialization data. For example, the receiver compares the extracted initialization data to a previously stored version of received initialization data. If they are the same, then the extracted initialization data is repeated initialization data and the receiver discards the repeated initialization data in step 420. If not, then it is “new” initialization data, which is now stored for comparison in the next received data burst. In any event, the receiver processes the content data (e.g., P-frames in MPEG-2) using the requisite initialization data in step 425. For example, if the data burst comprises “old” content data and “new” content data, then the previously received initialization data associated with the “old” content data is used for processing the “old” content data; and the “new” initialization data in the received data burst is used for processing the “new” content data.

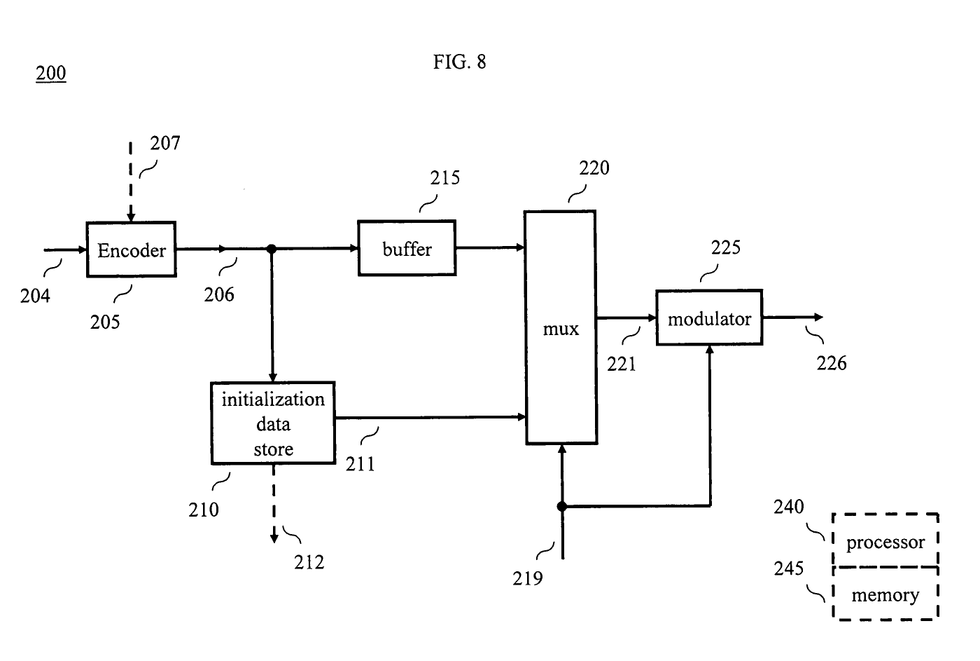

Turning now to FIG. 8, an illustrative embodiment of a transmitter 200 is shown in accordance with the principles of the invention. Only those portions relevant to the inventive concept are shown. The transmitter is a processor-based system and includes one, or more, processors and associated memory as represented by processor 240 and memory 245 shown in the form of dashed boxes in FIG. 8. In this context, computer programs, or software, are stored in memory 245 for execution by processor 240 and, e.g., implement encoder 205. Processor 240 is representative of one, or more, stored-program control processors and these do not have to be dedicated to the transmitter function, e.g., processor 240 may also control other functions of the transmitter. Memory 245 is representative of any storage device, e.g., random-access memory (RAM), read-only memory (ROM), etc.; may be internal and/or external to the transmitter; and is volatile and/or non-volatile as necessary.

The elements shown in FIG. 8 comprise an encoder 205, initialization data store 210, buffer 215, multiplexer (mux) 220 and modulator 225. A data signal 204 representing, e.g., multimedia content such as video and/or audio, is applied to encoder 205. The latter encodes the data signal 204 and provides encoded data signal 206 comprising initialization data and content data. For example, encoder 205 is an MPEG-2 encoder and, for video, encoded data signal 206 represents a stream of I-frames (initialization data) and P-frames (content data). Encoded data signal 206 is applied to buffer 215 for storage, and also applied to initialization data store 210. Buffer 215 temporarily stores the encoded data between data bursts. Initialization data store 210 stores initialization data as it is generated by encoder 205. As such, the most-recently generated initialization data is always available for transmission in a data burst in accordance with the principles of the invention. Mux 220 either provides the encoded data from buffer 215 or the initialization data stored in initialization data store 210 to modulator 225 for transmission in a data burst. Modulator 225 provides a modulated signal 226 for transmission via an upconverter and antenna (both not shown in FIG. 8). The selection of the data provided by mux 220 is controlled via control signal 219 (e.g., from processor 240). For example, at the start of a data burst, processor 240 controls mux 220 to provide the stored initialization data to modulator 225. Then, for the remainder of the data burst on-time processor 240 controls mux 220 to provide the encoded data from buffer 215 to modulator 225. During the off-time of the data burst, processor 240 disables mux 220 via control signal 219.

As noted earlier, a feedback mechanism can be used to alter the bit rate provided by encoder 205 in order to account for the size of the repeated initialization data in every data burst. This is illustrated in FIG. 8 via control signals 207 and 212, which are shown in dashed-line form. In particular, processor 240 determines the size, e.g., in bytes, of the initialization data stored in initialization data store 210 via control signal 212. As such, processor 240 then alters the encoding rate of encoder 205 via control signal 207 to compensate for the presence of the repeated initialization data in the data burst.

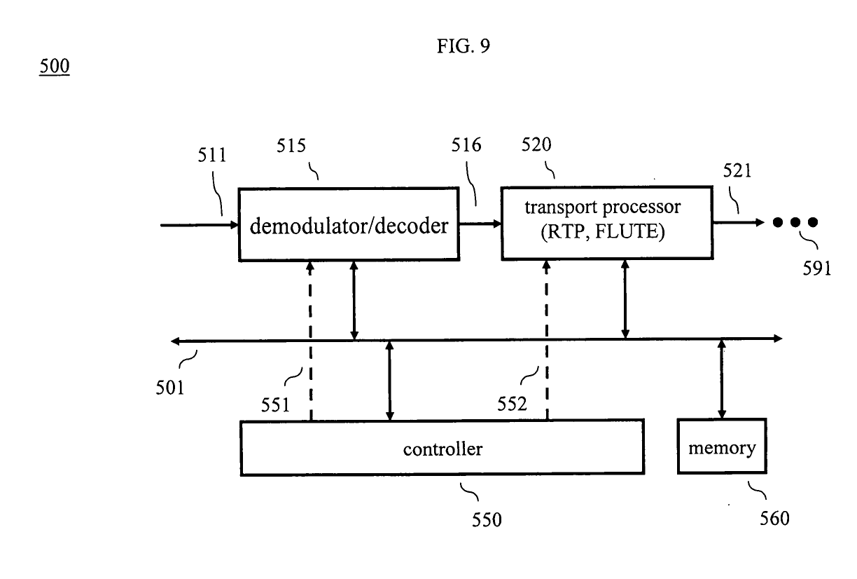

Referring now to FIG. 9, an illustrative embodiment of a receiver 500 in accordance with the principles of the invention is shown. Only that portion of receiver 500 relevant to the inventive concept is shown. Receiver 500 is representative of any processor-based platform, e.g., a PC, a personal digital assistant (PDA), a cellular telephone, a mobile digital television (DTV), etc. Receiver 500 includes demodulator/decoder 515, transport processor 520, controller 550 and memory 560. It should be noted that other components of a receiver, such as an analog-to-digital converter, front-end filter, etc., are not shown for simplicity. Both transport processor 520 and controller 550 are each representative of one or more microprocessors and/or digital signal processors (DSPs) and may include memory for executing programs and storing data. In this regard, memory 560 is representative of memory in receiver 500 and includes, e.g., any memory of transport processor 520 and/or controller 550. An illustrative bidirectional data and control bus 501 couples various ones of the elements of receiver 500 together as shown. Bus 501 is merely representative, e.g., individual signals (in a parallel and/or serial form) may be used, etc., for conveying data and control signaling between the elements of receiver 500. Demodulator/decoder 515 receives a signal 511, via an antenna and downconverter (not shown). Demodulator/decoder 515 performs demodulation and decoding of signal 511 and provides a decoded signal 516 to transport processor 520. Transport processor 520 is a packet processor and implements both a real-time protocol and FLUTE/ALC protocol stack to recover either real-time content or file-based content. Transport processor 520 provides content as represented by content signal 521 to appropriate subsequent circuitry (as represented by ellipses 591). Transport processor 520, in accordance with the above-described flow chart, recovers content and discards repeated initialization data. Controller 560 performs power management of transport processor 520 and demodulator/decoder 515 in accordance with the principles of the invention via control signals 551 and 552 (via bus 501).

In view of the above, and in accordance with the principles of the invention, faster channel, or service, acquisition is achieved by repeating initialization data in every data burst. It should be noted that although the inventive concept was illustrated in the context of an MPEG-2 encoded signal, the inventive concept is not so limited and is applicable to other types of encoding or transmission schemed that require initialization.

For example, in another illustrative embodiment of the invention, an apparatus provides a service that includes video. In particular, the apparatus encodes a signal for providing an H.264 encoded signal having associated initialization data such as parameter sets; and transmits the signal, wherein the transmitted signal occurs in bursts for conveying the H.264 encoded signal, wherein each burst has a duration and occurs in a time slicing cycle, each time slicing cycle comprising at least the burst duration and an off-time, and wherein at least one parameter set is conveyed in a burst and repeated in every following burst until a new parameter set is received for transmission.

In another illustrative embodiment of the invention, an apparatus receives a signal, wherein the signal occurs in bursts and conveys an H.264 encoded signal, wherein each burst has a duration and occurs in a time slicing cycle, each time slicing cycle comprising at least the burst duration and an off-time; recovers initialization data, e.g., at least one parameter set, from every received burst, and discards a recovered parameter set that has been repeated from a previously received burst. As a result, the apparatus can fully utilize the H.264 encoded video within each burst thus facilitating faster channel acquisition and recovery from errors.

In another illustrative embodiment of the invention, an apparatus provides a service that includes video and audio, which are transmitted as separate RTP streams. In particular, the apparatus encodes a signal for providing separate RTP streams for video and audio, the video and audio streams having associated initialization data such as RTCP sender reports; and transmits the signal, wherein the transmitted signal occurs in bursts for conveying the video and audio streams, wherein each burst has a duration and occurs in a time slicing cycle, each time slicing cycle comprising at least the burst duration and an off-time, and wherein at least one RTCP sender report is conveyed in a burst and repeated in every following burst until a new RTCP sender report is received for transmission.

In another illustrative embodiment of the invention, an apparatus receives a signal, wherein the signal occurs in bursts and conveys separate video and audio RTP streams, wherein each burst has a duration and occurs in a time slicing cycle, each time slicing cycle comprising at least the burst duration and an off-time; recovers initialization data, e.g., at least one RTCP sender report, from every received burst, and discards a recovered RTCP sender report that has been repeated from a previously received burst. As a result, the apparatus can fully utilize the separate RTP streams within each burst thus facilitating faster channel acquisition and recovery from errors.

In another illustrative embodiment of the invention, an apparatus provides a service that includes video. In particular, the apparatus encodes a signal in accordance with RObust Header Compression (ROHC) (RFC 3095) for providing an ROHC encoded signal having associated initialization data such as periodic initialization and refresh (IR) packets; and transmits the signal, wherein the transmitted signal occurs in bursts for conveying the ROHC encoded signal, wherein each burst has a duration and occurs in a time slicing cycle, each time slicing cycle comprising at least the burst duration and an off-time, and wherein at least one IR packet is conveyed in a burst and repeated in every following burst until a new IR packet is received for transmission.

In another illustrative embodiment of the invention, an apparatus receives a signal, wherein the signal occurs in bursts and conveys an ROHC encoded signal, wherein each burst has a duration and occurs in a time slicing cycle, each time slicing cycle comprising at least the burst duration and an off-time; recovers initialization data, e.g., at least one IR packet, from every received burst, and discards a recovered IR packet that has been repeated from a previously received burst: As a result, the apparatus can fully utilize the ROHC encoded video within each burst thus facilitating faster channel acquisition and recovery from errors.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIGS. 5-7, etc. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method comprising:
encoding a signal for providing an encoded signal having associated initialization data; and
transmitting the encoded signal, wherein the transmitted signal occurs in bursts for conveying the encoded signal, wherein each burst has a duration and occurs in a time slicing cycle, each time slicing cycle comprising at least the burst duration and an off-time, and wherein the initialization data is sent in a burst and repeated in every following burst until new initialization data is received for transmission.

2. The method of claim 1, wherein the initialization data is one of an MPEG-2 I-frame, an H-264 parameter set, an RObust Header Compression Initialization Refresh packet and an RTCP sender report.

3. The method of claim 1, wherein the repeated initialization data has a size in bytes and wherein the encoding step includes:
adjusting a bit rate of the encoded signal as a function of the size of the repeated initialization data.

4. A method comprising:
receiving a signal, wherein the signal occurs in bursts and conveys an encoded signal, wherein each burst has a duration and occurs in a time slicing cycle, each time slicing cycle comprising at least the burst duration and an off-time;
recovering initialization data from every received burst, wherein the initialization data is associated with the encoded signal; and
discarding recovered initialization data that has been repeated from a previously received burst.

5. The method of claim 4, wherein the initialization data is one of an MPEG-2 I-frame, an H-264 parameter set, an RObust Header Compression Initialization Refresh packet and an RTCP sender report.

6. Apparatus comprising:
an encoder for encoding a signal to provide an encoded signal having associated initialization data; and
a modulator for transmitting the encoded signal, wherein the transmitted signal occurs in bursts for conveying the encoded signal, wherein each burst has a duration and occurs in a time slicing cycle, each time slicing cycle comprising at least the burst duration and an off-time, and wherein the initialization data is sent in a burst and repeated in every following burst until new initialization data is received for transmission.

7. The apparatus of claim 6, wherein the initialization data is one of an MPEG-2 I-frame, an H-264 parameter set, an RObust Header Compression Initialization Refresh packet and an RTCP sender report.

8. The apparatus of claim 6, wherein the repeated initialization data has a size in bytes and wherein the encoder adjusts a bit rate of the encoded signal as a function of the size of the repeated initialization data.

9. The apparatus of claim 6, further comprising:
a buffer for storing the encoded signal;
a buffer for storing repeated initialization data; and
a multiplexer for providing either the repeated initialization data or the stored encoded signal to the modulator for transmission.

10. Apparatus comprising:
a demodulator for providing a demodulated signal; wherein the demodulated signal occurs in bursts and conveys an encoded signal, wherein each burst has a duration and occurs in a time slicing cycle, each time slicing cycle comprising at least the burst duration and an off-time; and
a processor for recovering initialization data from every received burst, wherein the initialization data is associated with the encoded signal; and wherein the processor discards recovered initialization data that has been repeated from a previously received burst.

11. The apparatus of claim 10, wherein the initialization data is one of an MPEG-2 I-frame, an H-264 parameter set, an RObust Header Compression Initialization Refresh packet and an RTCP sender report.
